(19) United States
(12) Patent Application Publication
(10) Pub. No.: US 2018/0051488 A1
(43) Pub. Date: Feb. 22, 2018

(54) BAG LOCK DEVICE AND METHOD FOR USING THE SAME

(71) Applicant: Gatekeeper Innovation Inc., Sacramento, CA (US)

(72) Inventors: Joseph Simpson, Sacramento, CA (US); John Steel, Sacramento, CA (US)

(21) Appl. No.: 15/240,959

(22) Filed: Aug. 18, 2016

(51) Int. Cl. E05B 65/52; E05B 37/00; E05B 37/04; B65D 33/16; B65D 55/14

(52) U.S. Cl. CPC E05B 65/52; E05B 37/0048; B65D 55/145; B65D 33/1666; E05B 37/04

(57) ABSTRACT

A bag lock device and method for use are disclosed. The bag lock device may be used, in some embodiments, for re-sealable bags that contain contents that should be secure from unauthorized users. In one implementation, the bag lock device may include a bag magazine and a combination lock which secures the bag onto the magazine carriage.

### FIELD

The disclosure relates generally to a device and method for securing the contents of a bag and in particular to a device and method for securing the contents of a re-sealable bag.

### BACKGROUND

Modernly, various items/products are sold in bags to customers. Those bags may be such that the bag is sealed when sold to the customers, but cannot be re-sealed once it has been opened by the consumer. In some cases when the opened bag has contents (such as items or products that may need to be secured from access by unauthorized users), it is desirable to provide a lock that is capable to locking the bag after it has been opened against access by unauthorized users.

Some bags with contents that are sold to consumers are re-sealable meaning that the consumer can initially open the bag, but the bag is re-sealable by the consumer after it is opened. A typical mechanism for a re-sealable bag is that the bag must be initially opened by cutting or tearing the top of the bag, but the bag has plastic or Velcro resealing element beneath the top of the bag that allows the user to re-seal the bag after it has been opened. Similar to the above bags, these re-sealable bags may have contents (such as items or products that may need to be secured from access by unauthorized users) so it is desirable to provide a lock that is capable to locking the re-sealable bag after it has been opened against access by unauthorized users.

### BRIEF DESCRIPTION OF THE DRAWINGS

FIG. 1 illustrates an implementation of a bag with a bag lock device locked onto the bag opening;

FIGS. 2A and 2B illustrate a typical bag with a sealing feature and an exploded view of the assembled bag with the bag lock device, respectively;

FIG. 2C illustrates a typical bag with a sealing feature being placed onto the bag lock device;

FIGS. 3A-3B are two views of an implementation of the bag magazine that is part of the bag lock device;

FIG. 3C illustrates a sectional view of the bag magazine along line A-A in FIG. 3A;

FIG. 3D illustrates a sectional view of the bag magazine along line B-B in FIG. 3A;

FIG. 4 is an exploded assembly diagram illustrating an implementation of a locking device that is part of the bag lock device;

FIGS. 5A-5C illustrate an implementation of a lock housing that is part of the bag lock device;

FIGS. 6A illustrate an implementation of a tension plate of the bag lock device;

FIG. 6B illustrate an implementation of a lock plate of the bag lock device;

FIGS. 7A-7C illustrates an implementation of a combination wheel of the bag lock device; and

FIGS. 8A-8F illustrate an implementation of a release mechanism of the bag lock device.

### DETAILED DESCRIPTION OF ONE OR MORE EMBODIMENTS

The disclosure is particularly applicable to a bag lock device that may be used to securely close a bag and it is in this context that the disclosure will be described. It will be appreciated, however, that the bag locking device has greater utility since it may be used to seal other types of bags including bags that are not resealable as well as other types of bag.

A bag lock device is disclosed that is a device for securing the content of a bag. There are some products that are sold in re-sealable bags which contents should be secure from unauthorized users. The bag lock device may have a bag magazine and a combination lock which secures the bag onto the magazine carriage. A bag can be put onto the device by folding the bag near the top then sliding it onto the bag magazine. Once the bag is on the bag magazine, the narrow slot at the bottom of the bag magazine prevents the bag from being able to be removed except in the direction it was originally put on. The bag can then be locked onto the bag magazine with a combination lock. When the combination is in the unlocked position it can easily be removed. The combination lock is removed in the same linear direction the bag is put onto the bag magazine. A method for using the bag lock device to lock or unlock a bag is also disclosed.

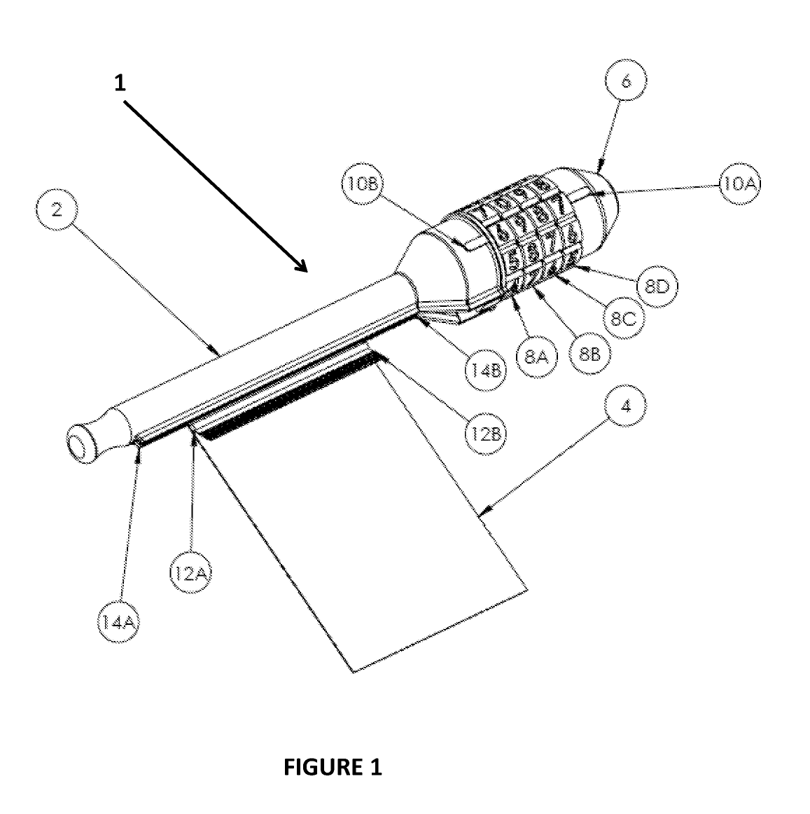

FIG. 1 illustrates an implementation of a bag 4 with a bag lock device 1 locked onto the bag opening in a locked position. In one implementation, the bag 4 has been folded over and slid/placed/set inside a bag magazine (2) of the bag lock 1 that also has a lock assembly (6) that includes cogs 8A-D, a housing and one or more indicators 10A, 10B. In other implementations, the bag lock 1 may have a gate or any other mechanism that may prevent the bag from being removed from the bag magazine 2 when the bag lock 1 is in the locked position. In one implementation, the lock assembly 6 may be a commercially available combination bicycle lock as shown in FIG. 1 and further described, for example, in U.S. Pat. No. 4,445,348 or U.S. Pat. No. 5,636,539. In other implementations, the lock assembly 6 may be various other locks that can prevent the bag 4 from being slipped off of the bag magazine 2. For example, the lock assembly may be a lock that has only number symbols (as shown in FIG. 1), but may also have alphanumeric cogs or cogs with other symbols of them that allow a user to set a combination code that opens the lock assembly 6. The lock assembly may also be other forms of locking mechanisms and devices that may prevent the bag 4 from being slipped off of the bag magazine 2. The lock assembly 6 prevents the bag 4 from being slipped off of the bag magazine (2) effectively securing the contents inside of the bag and preventing unauthorized users from accessing the contents inside of the bag 4 without the proper combination.

In the locked state shown in FIG. 1, the locking combination is shown mixed up on a set of number wheels (8A-D) in one implementation. The lock assembly 6 may have one or more combination line indicators (10A-B) that designate the location of the locked combination, which may be placed at any orientation about the number wheels when number wheels are used as part of the lock assembly 6. As shown in FIG. 1, the bag magazine 2 may have a width (such as a distance between 14A and 14B) that may be of any length necessary to fit the length of the bag 4 along its closure (distance between 12A and 12B). The bag lock 1 may thus be made to have various different widths to accommodate different bags.

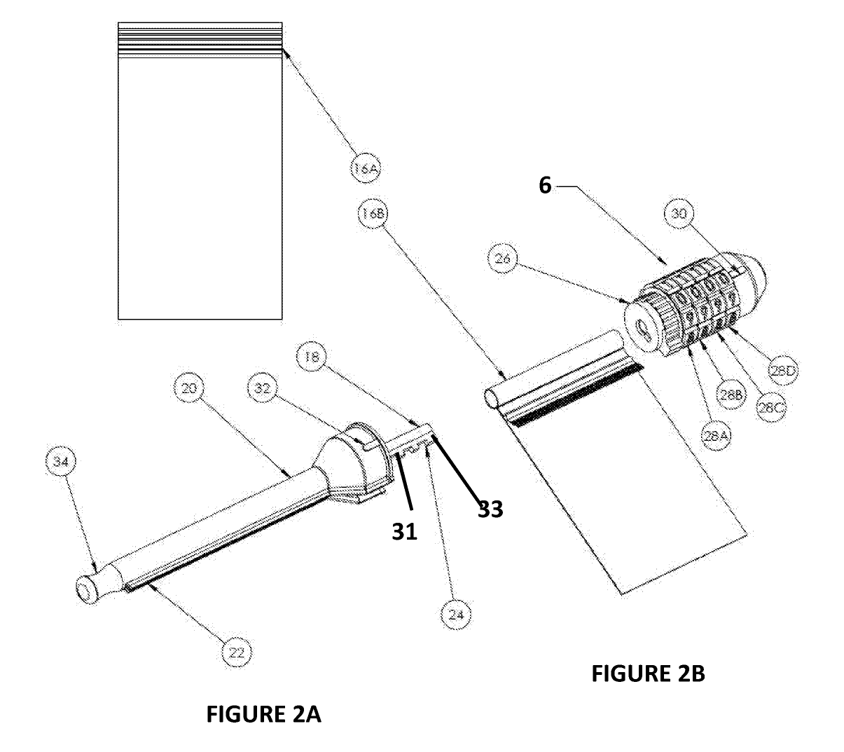

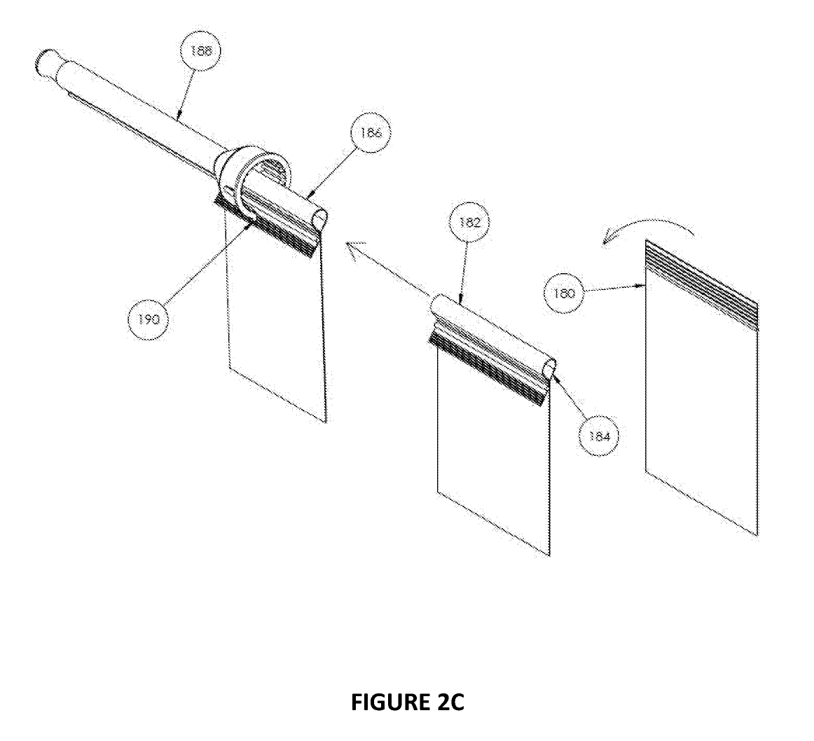

In the locked position, the bag lock 1 is connected to the end of the bag magazine 2. In an unlocked position (before a combination is initially entered into the bag lock or when the proper combination has been selected using the cogs 8A-8D), the lock assembly 6 may be removed from the bag magazine 2 (as shown in FIG. 2B) thus allowing the bag to be removed from the bag lock 1 so that the contents inside of the bag may be accessed.

FIGS. 2A and 2B illustrate a typical bag 4 with a sealing feature 16A and an exploded view of the assembled bag with the bag lock device, respectively. In the exploded view shown in FIG. 2B, a folded over sealing feature 16B of the bag 4 is shown that is similar to the sealing feature 16A except that item 16B is folded over in a position where it can slide onto the bag magazine on a lower slot shown at position (20). To place the bag 4 onto the bag lock 1 in one embodiment, the top of the bag 4 is folded over and slipped/slid/placed over a center rod (18) of the bag magazine (20). Both the contents inside the bag (solids, liquids, or gasses, food items, medical, etc.) and the sealing feature 16A on the bag prevent the bag from being pulled through the bag magazine.

FIG. 2C illustrates a typical bag 4 with a sealing feature being placed onto the bag lock device 1 and displays how the bag is folded and placed in the bag magazine. Specifically, as shown, a bag (180) may be folded as shown by the circular arrow, to form a circle at its lengthwise cross section as shown by feature 184. The bag must be folded such that there are no contents inside the bag between the zipper and the fold, while the contents sit inside the bag on the opposite side of the fold. The folded bag (182) may be placed in line with the bag magazine (188) and slid over the center shaft of the bag magazine as shown by feature 186 in relation to 188. The remainder of the bag is passed through the opening on the bag magazine (190), allowing the entire bag to slide all the way into the bag magazine.

In one embodiment, the lock assembly 6 may be a combination lock (26, 30, 28A-D) that works similar to a bicycle combination lock as described above. However, as described above, the bag lock may use other locking mechanisms to secure the bag to the bag magazine. At the end of the center rod on the bag magazine 20 (element 2 in FIG. 1) is a key feature (24) having one or more valley portions 31 and one or more top portions 33 that inserts into the lock assembly 6. The one or more valley portions 31 and one or more top portions 33 form one or more keys and those keys align with the internal combination lock and each ridge (between a valley portion and a top portion) matches a corresponding number of the cogs 28A-28D in the example shown in FIG. 2. When the bag lock is locked, the key feature 24 cannot be removed from the lock assembly 6 since the keys abut elements inside of the lock assembly 6 thus locking the bag 4 onto the bag magazine 2, 20. When the correct combination is entered into the lock assembly 6 by rotating the cogs 28A-28D in the implementation in FIG. 2, the lock assembly 6 can be removed from the key feature 24. Once the lock assembly 6 is placed on the bag magazine 2, 20, changing the numbers from the unlock combination/code (shown as “0000” in this figure, 28A-D) will effectively lock the bag into/on/in the device. A boss 34 may or may not be placed at the end of the bag magazine to add stylistic cues as well as provide the user a place to hold the device. Just as in FIG. 1, the combination indicators may be placed at any orientation about the device. If a combination is to be set by the user, a combination release knob (26) or any other mechanism may be used to operate the combination release/reset function.

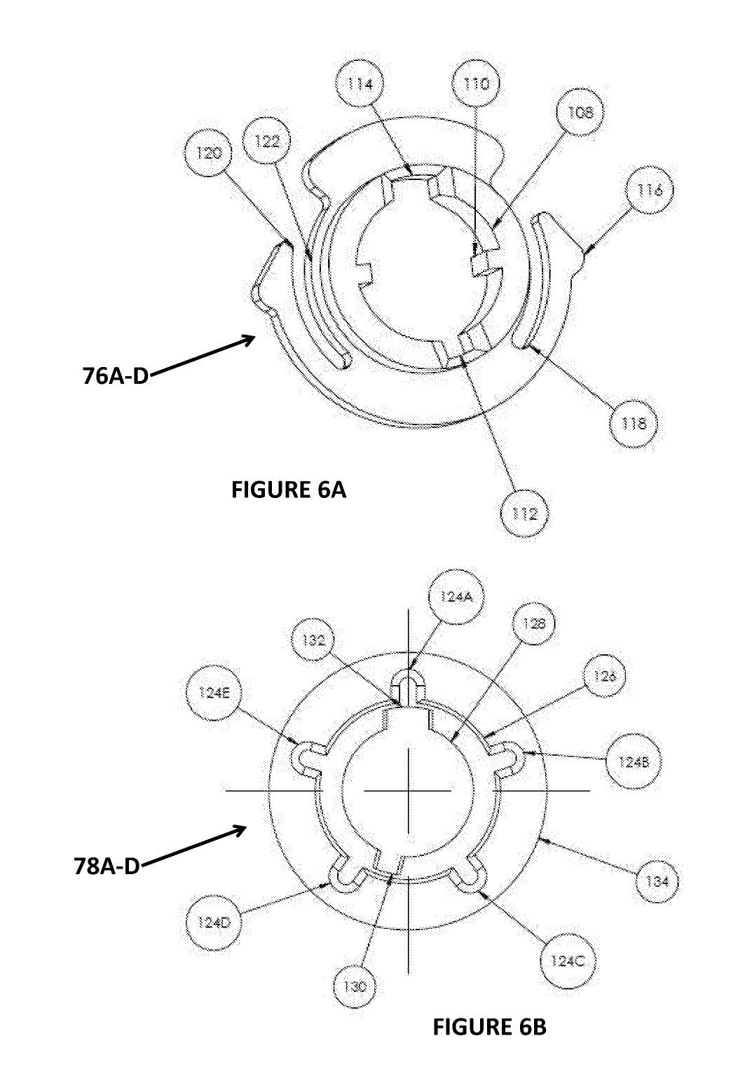

In this design the correct number positioning is shown at position (30) of the combination lock and position (32) on the bag magazine. This positioning of the number positioning can be set at any part of the circumference of the set combination and bag magazine, this would just require different orientation of the lock plate (shown in FIG. 6B), which is resettable in positioning.

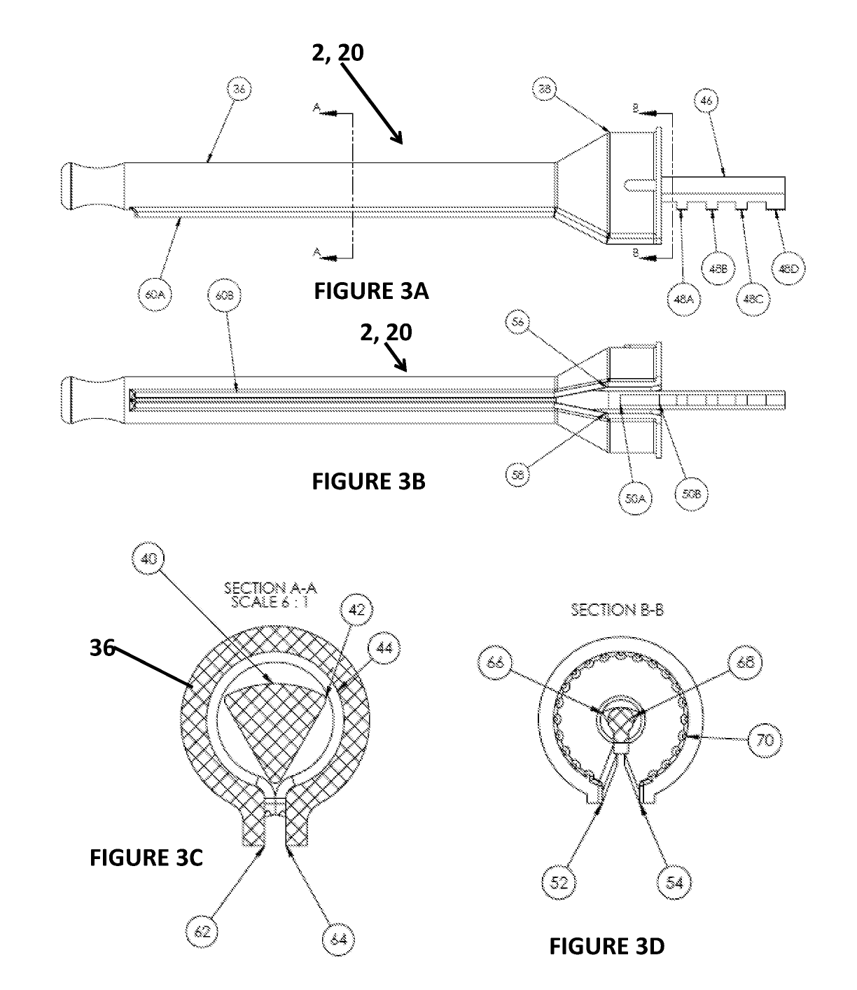

FIGS. 3A-3B are two views of an implementation of the bag magazine 2, 20 that is part of the bag lock device. FIG. 3C illustrates a sectional view of the bag magazine along line A-A in FIG. 3A and FIG. 3D illustrates a sectional view of the bag magazine along line B-B in FIG. 3A. The bag magazine 2, 20 may have a main body/housing (36) that encloses a center rod/shaft (40, 46 shown in FIGS. 3A and 3C) and the housing 36 has an opening (60A-B, 62, 64) along one side to allow a bag to fold over the center rod/shaft 40, 46 and slide into the housing 36. The opening (60A-B, 62, 64) may be tapered at a bell housing (38) as shown in features (56, 58, 52, and 54).

The center rod/shaft 40, 46 may have two separate cross sections as shown in FIGS. 3C and 3D. The portion that holds a bag inside of the bag magazine is called a sealing shaft (40) as shown in FIG. 3C. The distance between the sealing shaft 40 and the inside of the bag magazine (distance between (42) and (44), respectively as shown in FIG. 3C) shall be large enough to accommodate the thickness of a bag. The sealing shaft 40 is tapered into a keyed shaft (46). Features 66 and 68 in FIG. 3D show the tapering of the cross section. The keys on the shaft (48A-D, 50A-B) are separated at the proper distance such that it will operate with an accompanying lock. If the unlock combination is to be set by the user, there will exist a key (between 50A and 50B) to retain the lock reset mechanism while the lock is in place. The bell housing (38) accepts a lock that slips over the center rod/shaft and into the bell housing. The inside of the bell housing may be shaped to prevent rotation of the lock when in place to ease the use of the number/combo wheel/dials. The distance at the opening on the bell housing (distance between (52) and (54)) may or may not also be used as a mechanism to further prevent the rotation of the lock or the combination release knob.

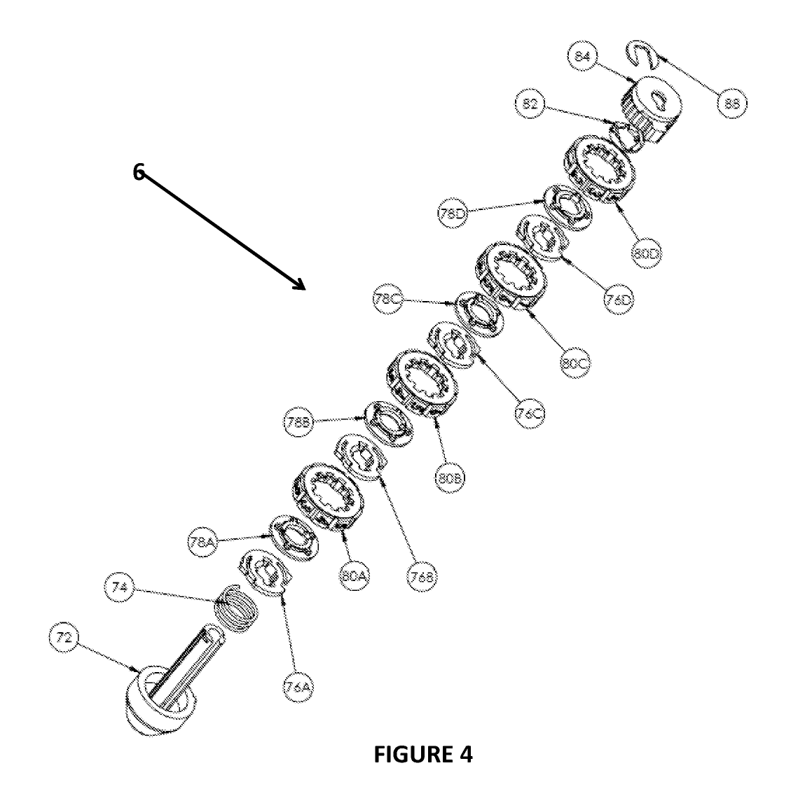

FIG. 4 is an exploded assembly diagram illustrating an implementation of a locking device 6 that is part of the bag lock device. The lock assembly 6 may have a lock housing (72) that is a capped hollow shaft with an opening along one side to accept the key feature (feature 46) of the bag magazine 2, 20 inside and to house the remainder of the lock assembly along the hollow shaft. The pieces of the lock assembly 6 may be assembled on the lock housing 72 as shown in FIG. 4: a spring (74) that tensions that other elements against each other, one or more tension plates (76A-D), one or more lock plates (78A-D) and one or more number/combo dial/wheel (80A-D) interspersed between each other as shown in FIG. 4. The elements (76), (78), and (80) may be repeatedly stacked to accommodate a combination with any number of digits, although FIG. 4 displays a lock with a four-digit combination. The lock assembly may further include a release washer (82), combination reset/release knob (84), and a C Clip (88). In an assembled lock assembly 6, the elements shown in FIG. 4 may be combined and tensioned b the spring 74 and assembled onto the lock housing 72 to provide the locking/unlocking capability of the bag lock.

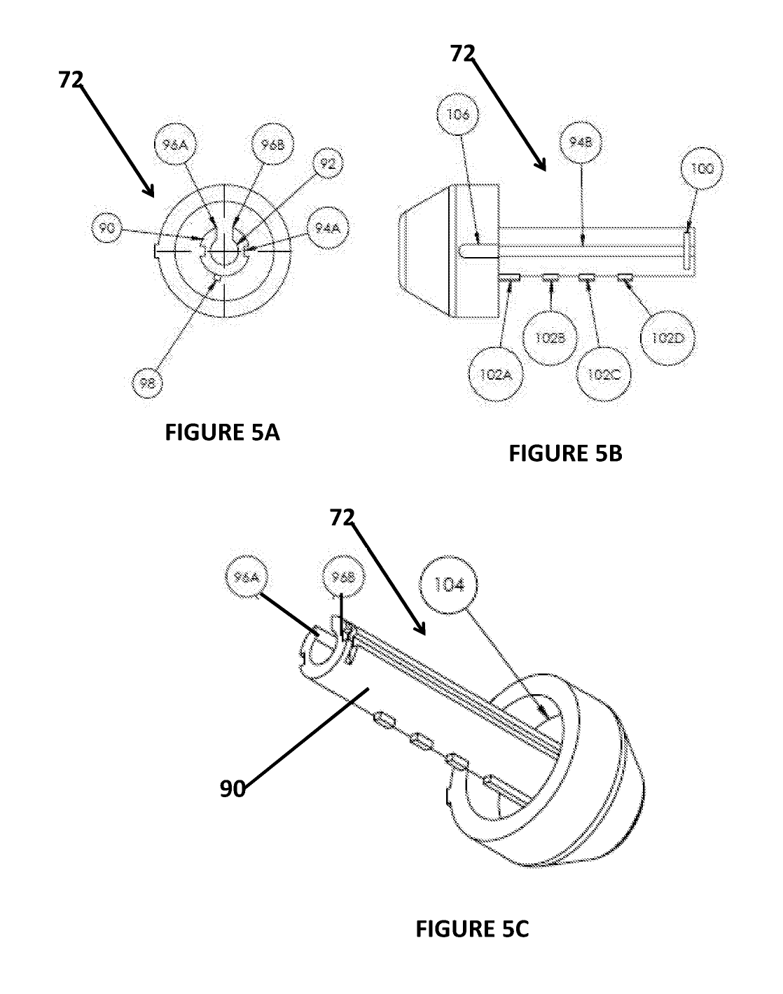

FIGS. 5A-5C illustrate an implementation of a lock housing 72 that is part of the bag lock device. The lock housing 72 may have a center shaft (90) that is hollow with a separation along its length so that each side of the center shaft (96A-B) leaves an open gap between the two sides. The locking housing 72 may further have two female detents along the shaft (94A-B) and a male detent (also known as a lock plate detent boss 98) that is separated along its length into one or more segments (102A-D) as shown in FIG. 5B. A spring recess is located at 104. The separation along the hollow shaft (96A-B) is to allow the key to protrude through enough to catch on the lock plates (shown in FIG. 4 for example) when the key passage on the lock plates (FIG. 6B, element 132) are rotated away from the separation. The female detents 94A-94B along the center shaft 90 on either side are to lock the rotational orientation of the tension plates 76A-76D and a reset washer (166). The separations along the lock plate detent boss (102A-D) allow the lock plates 78A-76D to rotate free, however if the combination is to be set by the user, the lock plate detent bosses 102A-102D will hold the lock plates rotational orientation via the lock plate detent (130) to allow the number wheels 80A-80D to spin free of the lock plate. The C clip (88) is placed in the C clip detent (100) on the lock housing to retain all of the pieces of the lock.

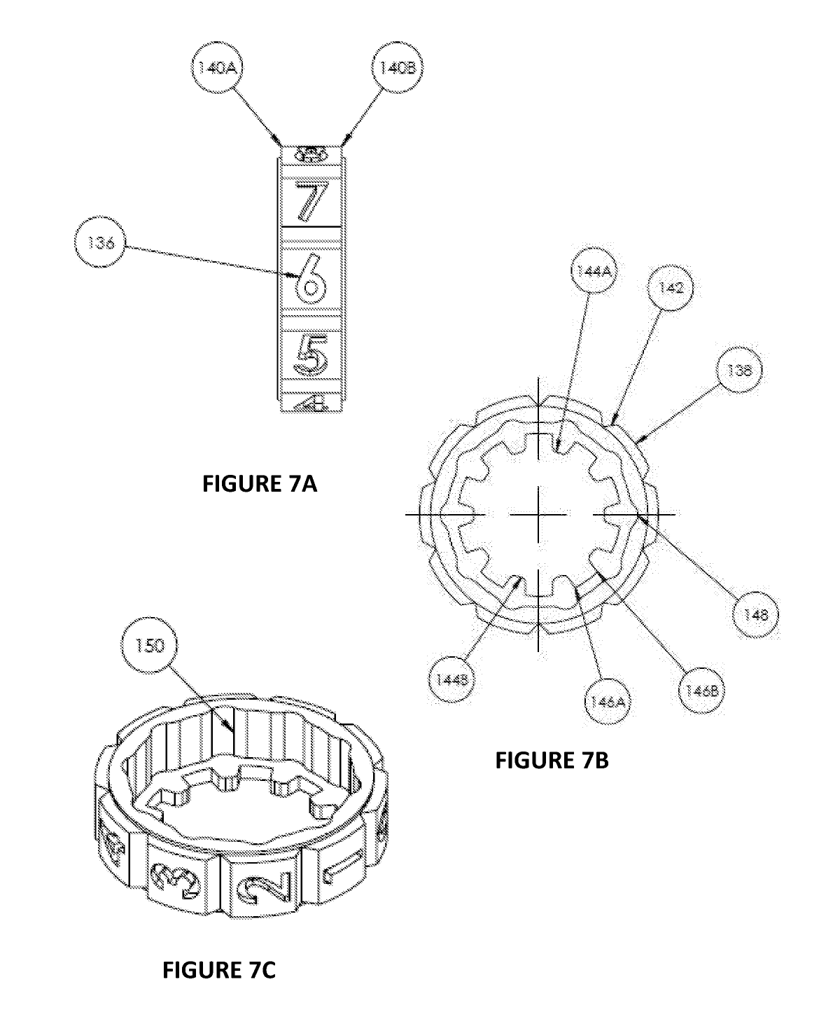

FIG. 6A illustrate an implementation of a tension plate 76A-76D of the bag lock device. Each tension plate provide the “click” feel when the number wheels 80A-80D are rotated. Each tension plate (76A, 76B, 76C, 76D) is placed inside a corresponding number wheel (80A, 80B, 80C, 80D, respectively for the implementation with a four digit combination) with each lock plate (78A, 78B, 78C, 78D, respectively for the implementation with a four digit combination). The rotational orientation of the tension plate is locked to the shaft of the lock housing 72 with lock housing detents (110) on either side of their inner diameter. The “click” feel on the number wheels (80A, 80B, 80C, 80D, respectively for the implementation with a four digit combination) is provided by a tension spring (116). An opening at 118 allows the tension spring to act as a spring in the radial direction. The wheel (FIGS. 7A-7C) has detents (148) to allow the tension spring to hold the wheel in place. When the user spins the number/combo wheel/dial, the tension spring leaves the detent by springing back, and clicks when it springs back into the next detent it will pass. A key passage (114) allows the keyed shaft of the bag magazine (46) to pass through. The lock plate detent passage (112) serves to further secure the rotational orientation of this part.

FIG. 6B illustrate an implementation of the lock plate (78A, 78B, 78C, 78D, respectively for the implementation with a four digit combination) of the bag lock device. Each lock plate (78A, 78B, 78C, 78D, respectively for the implementation with a four digit combination) is mated to and spins with a corresponding number/combo wheel/dial (80A, 80B, 80C, 80D, respectively for the implementation with a four digit combination) via bosses and detents. A set of lock bosses (124A-E) mate with the lock detents (146A,146B) on the number wheels as shown in FIGS. 7A-7C. The boss and detent mechanism may or may not allow the user to set their own unlock combination. If the user is to set their own combination, the lock plate may be pushed back from its mating position with the combination wheel, which will allow the combination wheels to spin free of the lock plate. An inner diameter (128) contains a key passage (132) and a lock plate detent (130). When pushed back, the lock plate detent (130) will catch onto the lock plate detent boss 102A-D on the lock housing to hold the lock plate's rotational orientation while the user sets their combination. When a user enters the unlock number/symbol/combo, the unlock opening, or key passage (132) on the lock plate will align with the opening on the shaft of the lock housing (96A-B), allowing the key feature on the bag magazine (feature 48A-D) to slide in or out of the shaft. The outer diameter (134) should fit inside of the number wheels.

FIGS. 7A-7C illustrates an implementation of a combination wheel (80A, 80B, 80C, 80D, respectively for the implementation with a four digit numerical combination) of the bag lock device. The symbols (136) on each wheel may be numbers in this example, but the bag lock may be implemented using symbols that may include numbers, shapes, letters, braille, or any other type of symbol that could be used to designate a combination. A symbol surface (all instances similar to 138, 136, repeated about the exterior) should be large enough for the symbols used. A width of the wheels (distance between 140A and 140B) should be wide enough for a user to spin on the mechanism by hand. There should be a separation, boss, detent, smoothness, or otherwise (142—all instances) between the numbers. The lock plate detents (144A-B and all similar instances) allow the lock plate bosses (124A-E) to mate between the detent separations (all similar distances between 146A and 146B). The click detents (all similar instances of 148) are referenced in the detailing in FIGS. 7A-7C, as the tension spring rests in these detents. Feature 150 displays the isometric view of the wheel to show the depth of the internal features.

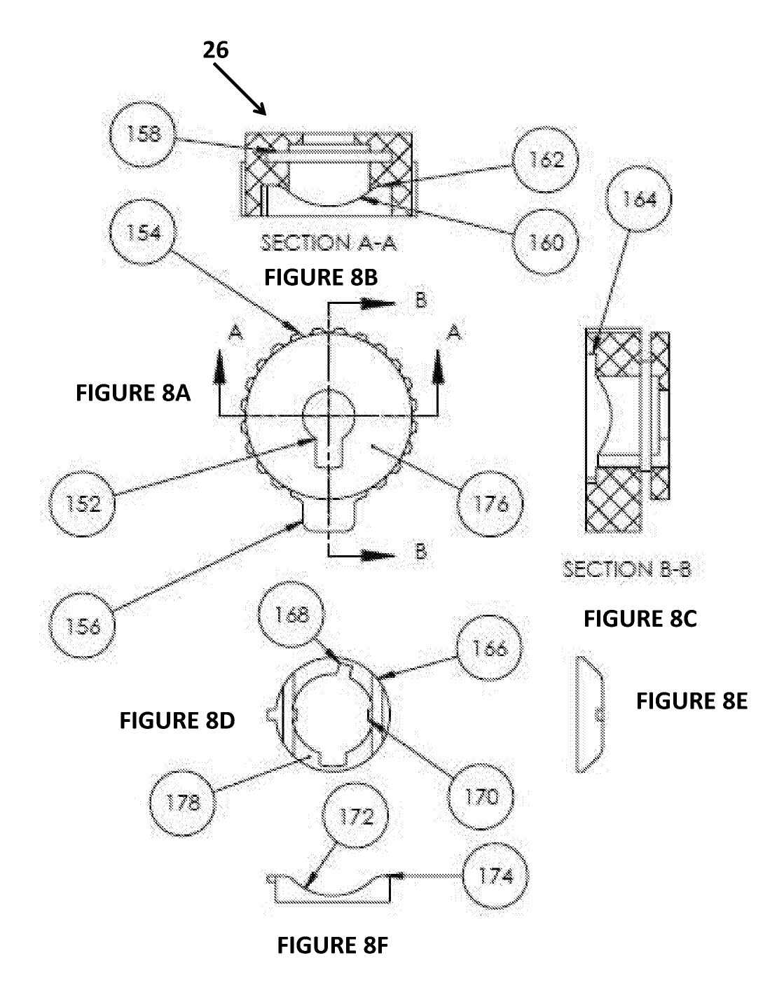

FIGS. 8A-8F illustrate an implementation of a release mechanism 26 of the bag lock device. The release mechanism 26 may have an end cap/release cap (176) that caps off the assembly and is held in place by a C type clip 88. In an implementation of the bag lock in which the combination is user adjustable/settable, the end cap 176 may twist 90 degrees while the lock is removed and the combination may be changed. This works by the end cap having a feature underneath (160, 162, 164) that has the opposite curvature (160, 172) as the release washer (178, curvature 172). The release washer has detents (170) to lock its rotational orientation along the lock housing. When the end cap is twisted, it pushes on the release washer, which pushes all of the lock plates just enough to release the lock plate bosses (124 A-E) from the number/combo wheel/dial detents (146 A-B) allowing the wheel/dial to spin free from the lock plate. The spring (74) applies a force on the tension plates and lock plates, which pushes the bosses on the lock plates into the detents on the wheels/dials creating the mate, as well as allow the release mechanism to work. When the new combination is chosen, the end cap may be rotated back to resting position. The grooves outside the end cap (154) lock into the grooves on the bag magazine (48A-D) The twist lever (156) adds leverage to ease the rotation of the end cap as well as locks the end cap inside the opening on the bell housing on the bag magazine (72).

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include an/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. A bag lock device, comprising:
a bag magazine having an element around which a bag may be wrapped to lock the bag onto the bag lock device;
a lock assembly that is configured to be removable coupled to the bag magazine to secure the bag onto the bag magazine; and
the bag magazine having a key feature that interacts with the lock assembly to lock the bag onto the bag magazine when the lock assembly is in a locked position.

2. The device of claim 1, wherein the key feature further comprises one or more key features that interact with elements contained inside of the lock assembly to lock the bag onto the bag magazine and release the bag from the bag magazine.

3. The device of claim 1, wherein the lock assembly further comprises one or more wheels that are rotatable to display an unlock combination.

4. The device of claim 3, wherein each wheel has a plurality of symbols that are used to select the unlock combination.

5. The device of claim 4, wherein the symbols are one of numbers, alphanumeric characters, braille.

6. The device of claim 3 wherein the lock assembly further comprises a tension plate and a lock plate associated with each wheel.

7. The device of claim 1 further comprising a release mechanism that permits an unlock combination to be changed.

8. The device of claim 1, wherein the lock assembly further comprises a release mechanism that permits an unlock combination to be changed.

9. The device of claim 1, wherein the bag magazine further comprises an opening along a length of the bag magazine through which the bag is placed.

10. The device of claim 1, wherein the bag magazine further comprises a housing and a shaft inside of the housing around which the bag is wrapped.

11. A method for operating a bag lock, comprising:
threading a bag into a bag magazine so that the end of the bag is wrapped around an element of the bag magazine;
inserting a lock assembly onto a key feature of the bag magazine; and
locking the lock assembly onto the bag magazine so that the bag cannot be removed from the bag magazine.

12. The method of claim 11 further comprising unlocking the lock assembly to permit the bag to be removed from around the element of the bag magazine.

13. The method of claim 12, wherein unlocking the lock assembly further comprising entering an unlock combination into a lock.

14. The method of claim 13, wherein entering an unlock combination into a lock further comprises rotating one or more symbol wheels so that the one or more symbol wheels shows the unlock combination.

15. The method of claim 11, wherein locking the lock assembly further comprises preventing the key feature from being removed from the lock assembly.

16. The method of claim 11 further comprising resetting the lock assembly when the lock assembly is in an unlocked position.

17. A method for operating a bag lock, comprising:
providing a bag locked onto a bag lock by threading a bag into a bag magazine so that the end of the bag is wrapped around an element of the bag magazine wherein the bag assembly is locked by a lock assembly; and
unlocking the lock assembly to permit the bag to be removed from around the element of the bag magazine.

18. The method of claim 17, wherein unlocking the lock assembly further comprising entering an unlock combination into a lock.

19. The method of claim 18, wherein entering an unlock combination into a lock further comprises rotating one or more symbol wheels so that the one or more symbol wheels shows the unlock combination.

20. The method of 17 further comprising locking the bag onto the bag magazine.

21. The method of claim 20, wherein locking the bag onto the bag magazine further comprises inserting a lock assembly onto a key feature of the bag magazine and locking the lock assembly onto the bag magazine so that the bag cannot be removed from the bag magazine.

22. The method of claim 21, wherein locking the lock assembly further comprises preventing the key feature from being removed from the lock assembly.

23. The method of claim 17 further comprising resetting the lock assembly when the lock assembly is in an unlocked position.
